(19) United States
(12) Patent Application Publication
(10) Pub. No.: US 2008/0172239 A1
(43) Pub. Date: Jul. 17, 2008

(54) INTERACTIVE LEGAL FORMS PROCESSING SYSTEM

(76) Inventors: Robert Henderson, West Palm Beach, FL (US); Lynn Drew, West Palm Beach, FL (US)

Correspondence Address: MCHALE & SLAVIN, P.A., 2855 PGA BLVD, PALM BEACH GARDENS, FL, 33410, US

(21) Appl. No.: 11/623,259

(22) Filed: Jan. 15, 2007

(51) Int. Cl. G06Q 50/00; G06F 15/16

(52) U.S. Cl. 705/1; 709/203

(57) ABSTRACT

The present invention is a system and method for automatically generating documents such as those required for divorce, eviction and small claims proceedings and other legal actions. A preferred embodiment of the system includes a server computer system and a user computer system connected to a network. The server computer system includes a memory for the storage of location-based divorce, eviction and small claims proceeding rules, a processor and a graphical user interface component. The user computer system includes a user interface component coupled to a processing component. The user interface component presents the graphical user interfaces generated by the graphical user interface component and receives responses to the presented graphical user interfaces. The responses include a selection of the location for the proceedings. The received responses are sent to the server and the server processor automatically generates documents based on the responses received.

### FIELD OF THE INVENTION

The present invention relates to a system and method for online preparation of documents and subsequent generation of the documents. The generated documents provide commonality in documents filed in divorce filings and other legal proceedings.

### BACKGROUND OF THE INVENTION

In many legal proceedings, a majority of the costs entailed are for the time and expertise required to complete the required paperwork. Even in simple legal proceedings wherein the proceeding itself is essentially a formality, time and expertise in completing the required forms are required. Obvious care must be taken to assure that such documents are readable, especially when the documents are prepared “pro se.” An example of a simple proceeding, commonly preformed “pro se”, is an uncontested divorce. In this proceeding there are still a number of documents and papers which must be prepared and filed. The completion of these documents is a tedious act that requires some expertise in reading and understanding the content and format of the documents. In addition, preparation of the forms in a readable form is imperative to the proceeding. Many people find the paperwork confusing and time consuming and therefore often turn to attorneys to complete the work.

With an increasingly large number of people having access to personal computers a large number of sources of blank forms and document templates have been created which are useful for legal proceedings. While these tools are helpful to those familiar with the legal profession, there exists a need to help the average layperson in the process of filling out legal paperwork, for example divorce documents, and to guide the average layperson as to which form needs to be filed for each different legal proceeding.

### DESCRIPTION OF THE PRIOR ART

U.S. Pat. No. 7,035,830 discloses an electronic filing system operated by a governmental agency which accepts the electronic filing of certain documents as if the filings were done in person. An individual must first register with the governmental agency which grants them permission to file electronic versions of legal documents online. Once an individual has completed the registration process and is placed in the government agency's database of authorized users they are granted access to the secure government Web-sites. With the access and authorized user can access the government Web-site from and remote terminal utilizing the Internet. The documents which are filed may be in the form of a graphic, such as a PDF or TIFF file or may be a text filed such as a “Word” document. Once the document has been received by the government agency an electronic “filed” stamp is imparted to the document. This system does not include any forms or documents that a user can complete or fill in. The forms and documents must be supplied by the user at their remote terminals.

U.S. Pat. No. 6,694,315 discloses an online document assembly and docketing system useful for legal proceedings. A user registers with the system and subsequent to approval is granted access thereto. The system allows attorneys and authorized individuals to complete and electronically file legal documents in legal proceedings. The system also maintains a record of all the documents filed in a particular proceeding and can set critical dates on which specific items must be filed. These dates are made available to all parties involved. The system also contains many of the legal forms and templates of documents which need to be filed in most legal proceedings. A document can remain on the system for review and completion at a later time prior to its being electronically filed. The user must know which documents and forms to use in each different legal proceeding. The system does not prompt the user or select the forms that are required for each different legal proceeding.

### SUMMARY OF THE INVENTION

The present invention is a system and method for generating court acceptable documents required for divorce, eviction, small claims and other proceedings. A preferred embodiment of the system includes a server computer system and a user computer system connected to a network. The server computer system includes a memory for the storage of location-based divorce, eviction and small claims proceeding rules, a processor and a graphical user interface component. The user computer system includes a user interface component coupled to a processing component. The user interface component presents the graphical user interfaces generated by the graphical user interface component and receives responses to the presented graphical user interfaces. The responses include a selection of the location for the proceedings. The received responses are sent to the server and the server processor automatically generates documents based on the responses received.

Accordingly, it is an objective of the instant invention to provide an online system and method for the preparation of all the required forms or documents for certain legal proceedings by an individual without legal training.

It is a further objective of the instant invention to enable a user to complete legal forms and documents by responding to an on-line inquire.

It is yet another objective of the instant invention to enable a user to complete these legal forms and documents at a service center kiosk or at home utilizing a computer accessing the Internet.

It is a still further objective of the invention to provide online assistance for the completion of certain legal forms and documents.

It is still a further objective of the invention to enable the system to retrieve and generate the required legal forms and documents based on information supplied by the user.

It is still another objective of the invention to print out the completed legal forms and documents so they may be timely filed at the appropriate location.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a system diagram of a preferred embodiment of the instant invention;

FIG. 2 is a screen display of the home page of the instant invention;

FIG. 3. is a screen display of a disclaimer of the instant invention;

FIG. 4. is a screen display of instructions for performing the present invention;

FIG. 5 is a screen display indicating a choice of legal proceedings;

FIG. 6 is a screen display of the beginning of a small claims proceeding;

FIG. 7 is a screen display of the court fees for a small claims proceeding;

FIG. 8 is a screen display of a Login page;

FIG. 9 is a screen display of another Login page;

FIG. 10 is a screen display of a page where plaintiff information is entered;

FIG. 11 is a screen display wherein further plaintiff information is entered;

FIG. 12 is a screen display wherein additional plaintiffs may be added;

FIG. 13 is a screen display wherein defendant information is entered;

FIG. 14 is a screen display wherein additional defendant information is entered;

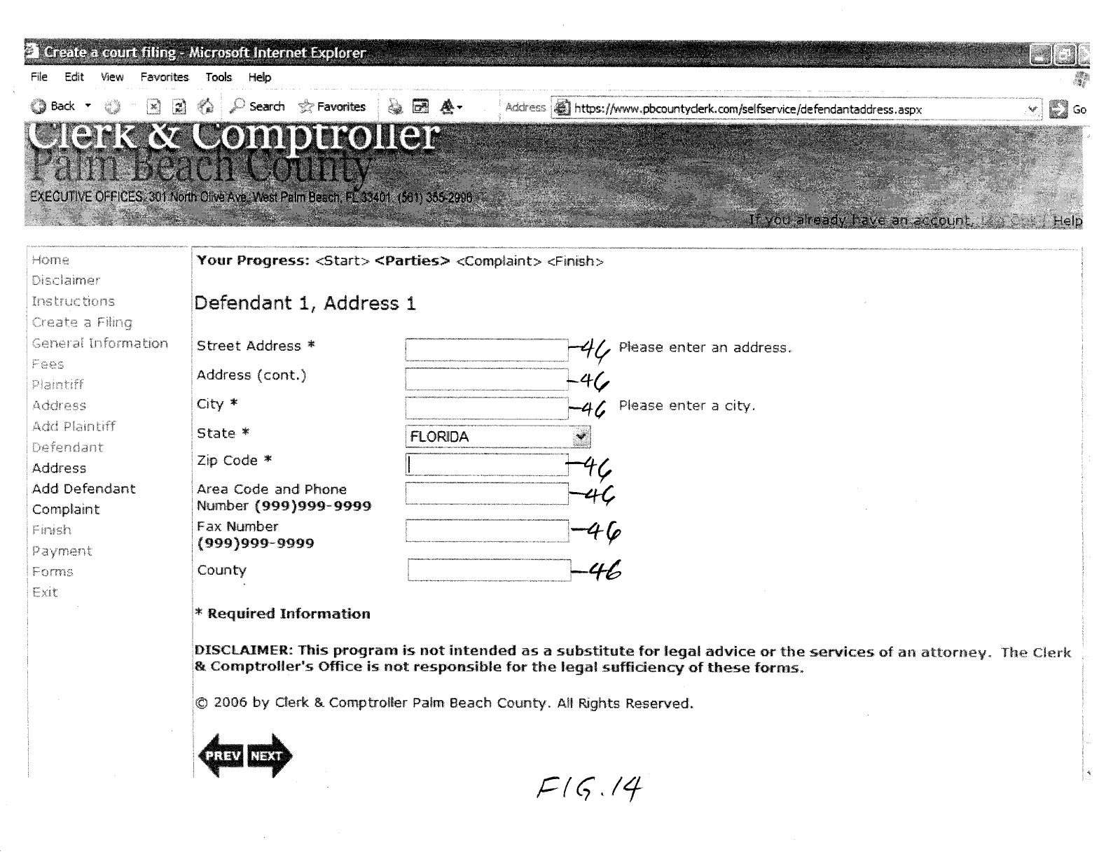

FIG. 15 is a screen display wherein additional defendants may be added;

FIG. 16 is a screen display wherein a small claim complaint is entered;

FIG. 17 is a screen display of the end of the question portion of the application of the instant invention;

FIG. 18 is a screen display of the payment page;

FIG. 19 is a screen display of the last page of the application of the instant invention; and

FIG. 20 is a diagram of how information is processed in the system of the instant invention.

### DETAILED DESCRIPTION OF THE INVENTION

The present invention is a system for the generation of certain legal forms and documents. These forms and documents are generated or automatically prepared based on input received from a user of the system, normally a pro se litigant, in response to certain questions. The system is designed for use by individuals who are not familiar with the legal system in this country. The present invention does not utilize a word processing software program to complete a template of the legal document but rather compiles the information provided by the user and generates the documents and court mandated filling forms based on the user's input. If the same information is required on different forms the invention recognizes this and provides this information in all the proper places. This helps to insure consistency and avoid costly errors when multiple forms or documents must be completed. Once all the information has been provided by the user and the forms or documents are complete, the user is still responsible for ensuring that they are complete, having the forms or documents notarized and filing the forms or documents with the appropriate office.

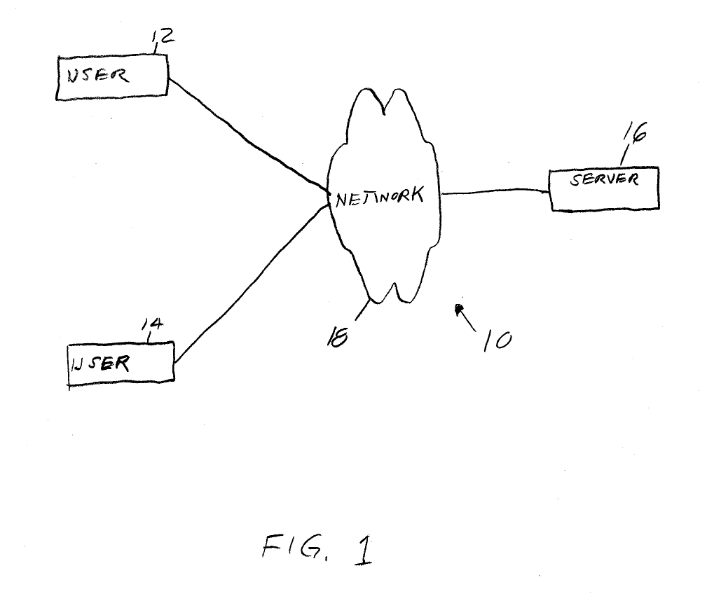

A preferred embodiment of the system 10, as illustrated in FIG. 1, includes a plurality of user systems or terminals 12, 14 and a server system 16 in communication with each another over a public or private wide area network 18 such as the Internet. The user and server systems may comprise computers including processors and memory. The server system 16 includes a plurality of interactive web pages which serve as a graphical user interface and guide the user through a series of questions which designed to gather the information necessary to complete the court mandated filling forms and documents required for certain legal proceedings, such as eviction or divorce. After all the questions on the interactive web pages have been answered a processor in the server system generates the necessary court documents. In divorce proceedings the processor also calculates alimony and child support payments based on the answered supplied by the user. The user can then take these documents have them notarized, if necessary, and file them with the court. The user can access the system from their home terminal 12 utilizing a PC or from a self service terminal 14 at a location readily accessible by the public.

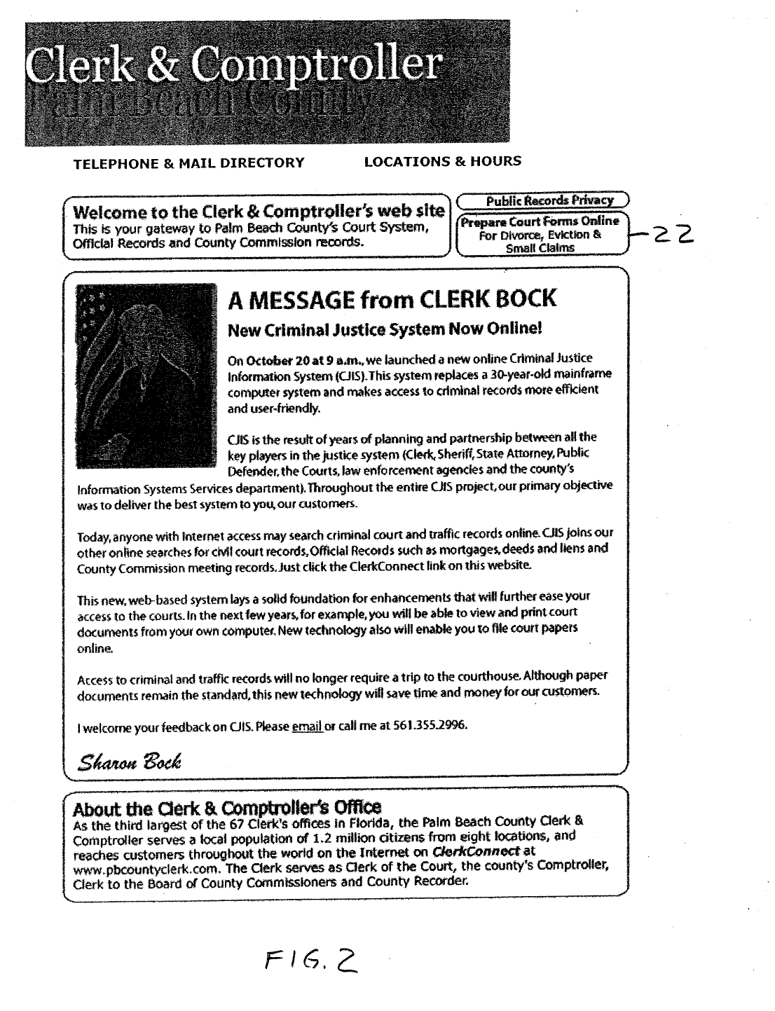

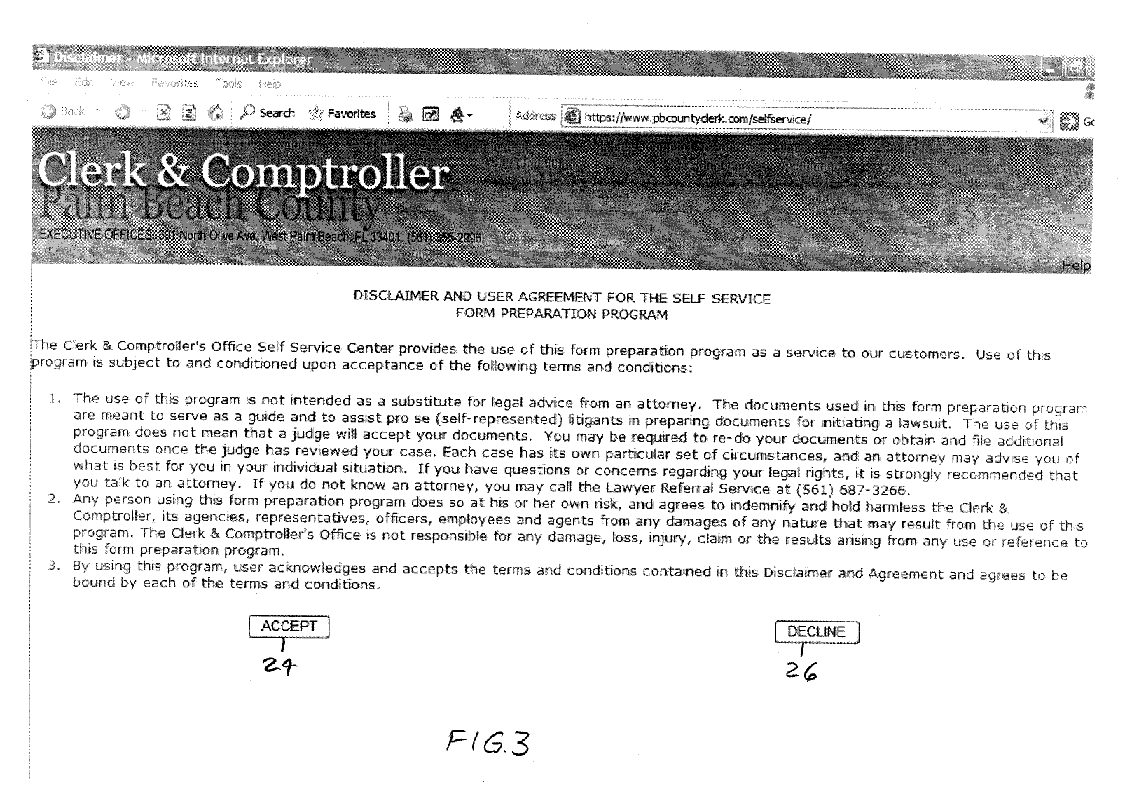

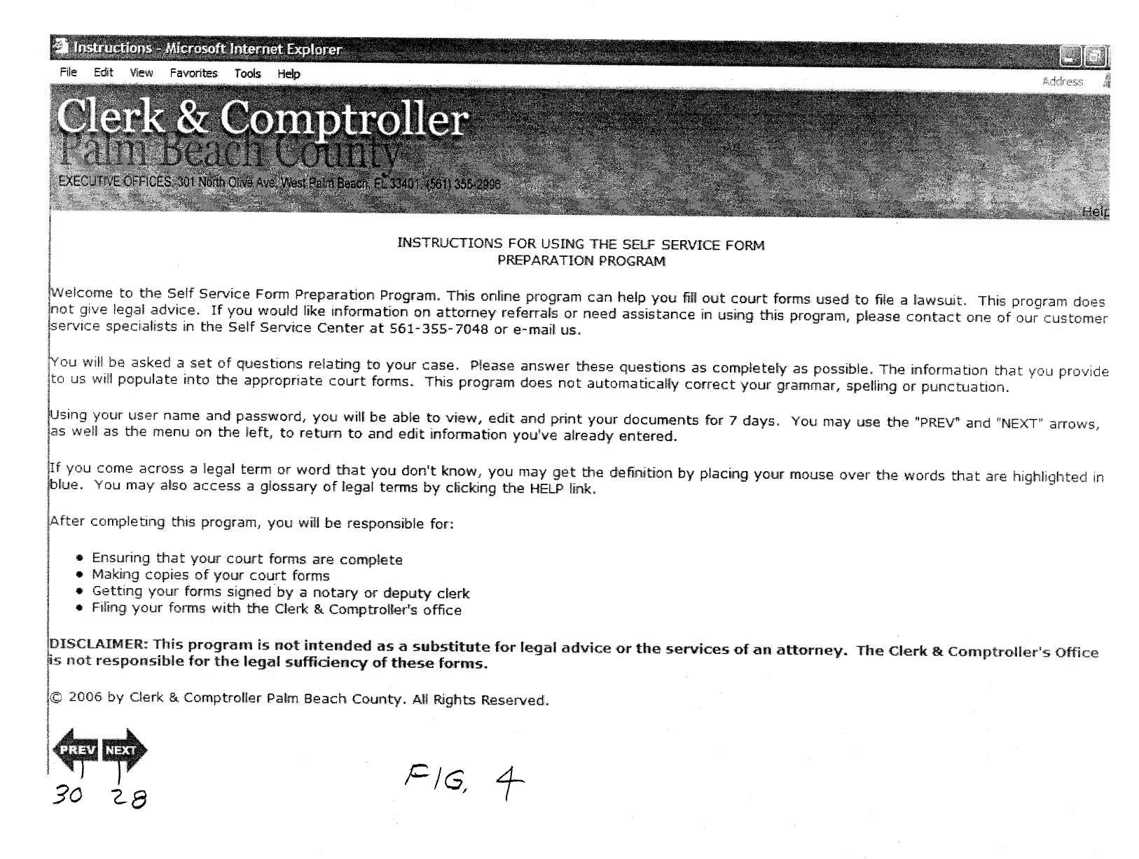

FIG. 2 illustrates how access to the present invention is normally obtained. A user accesses a web page of a governmental office, in this instance the County Clerk and Comptroller. Then the user clicks on a link 22 (Prepare Court Forms Online) to access the server system or computer 16 which contains the present invention. The server system can also be accessed directly by entering the correct URL. Once the server system 16 has been accessed, pluralities of interactive web pages are presented to the user in a logical order. The first web page presented is a disclaimer and user agreement (FIG. 3) for the user to read and accept or decline. This action is performed by clicking one of the “accept” 24 or “decline” 26 buttons on the lower portion of the page. The next web page contains a set of instructions (FIG. 4) for using the self service form preparation program. From this point on all the web pages contain “next” 28 and “previous” 30 arrows. By clicking on either of these the user may to proceed to the next page or return to a previous page.

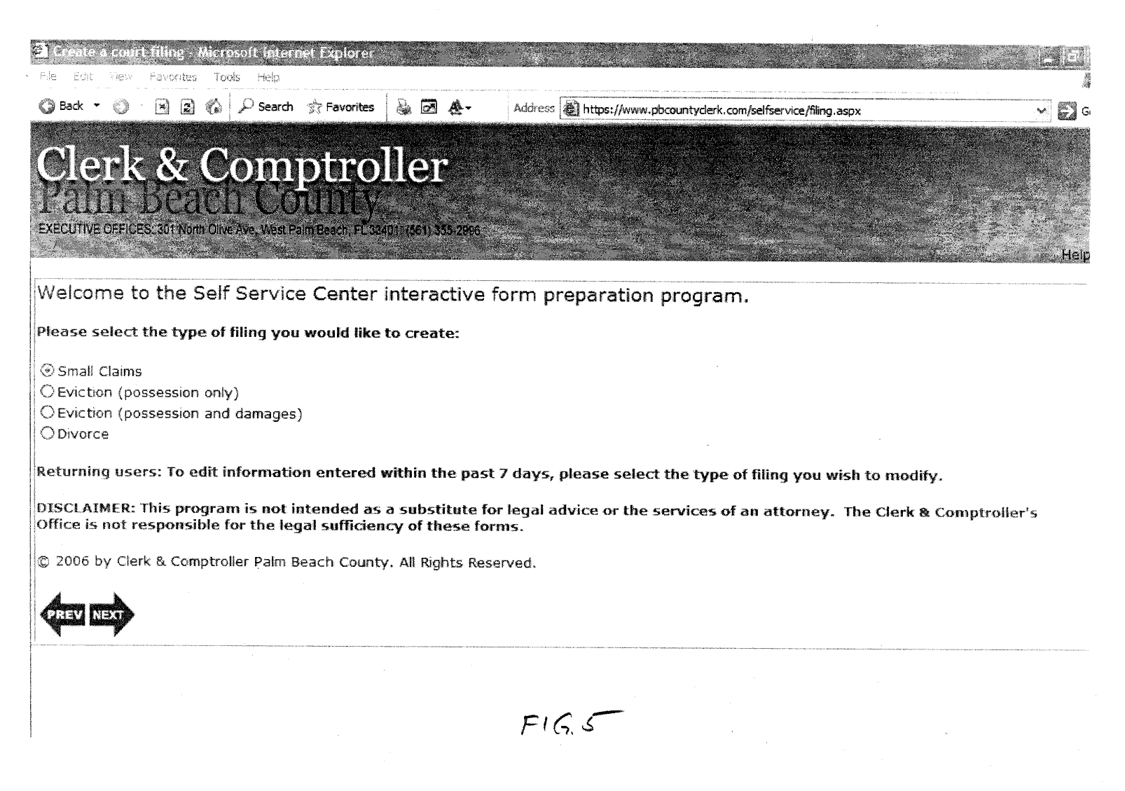

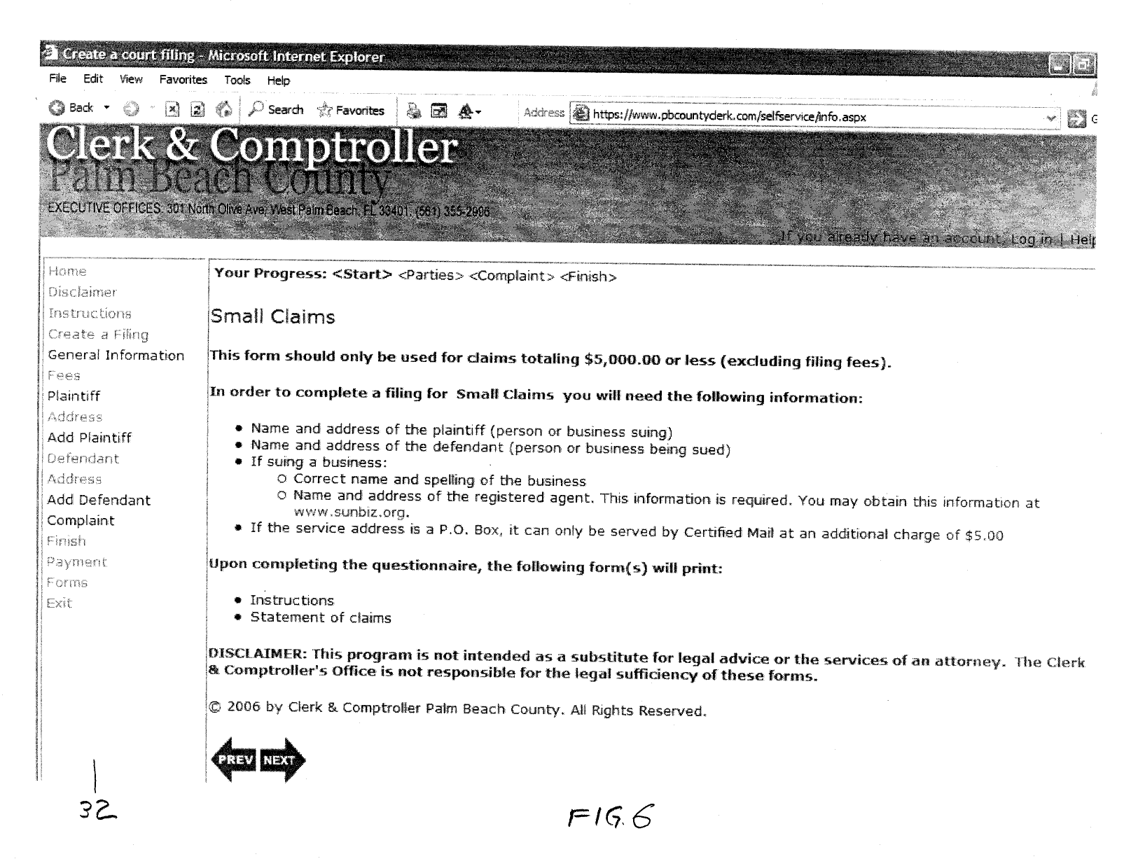

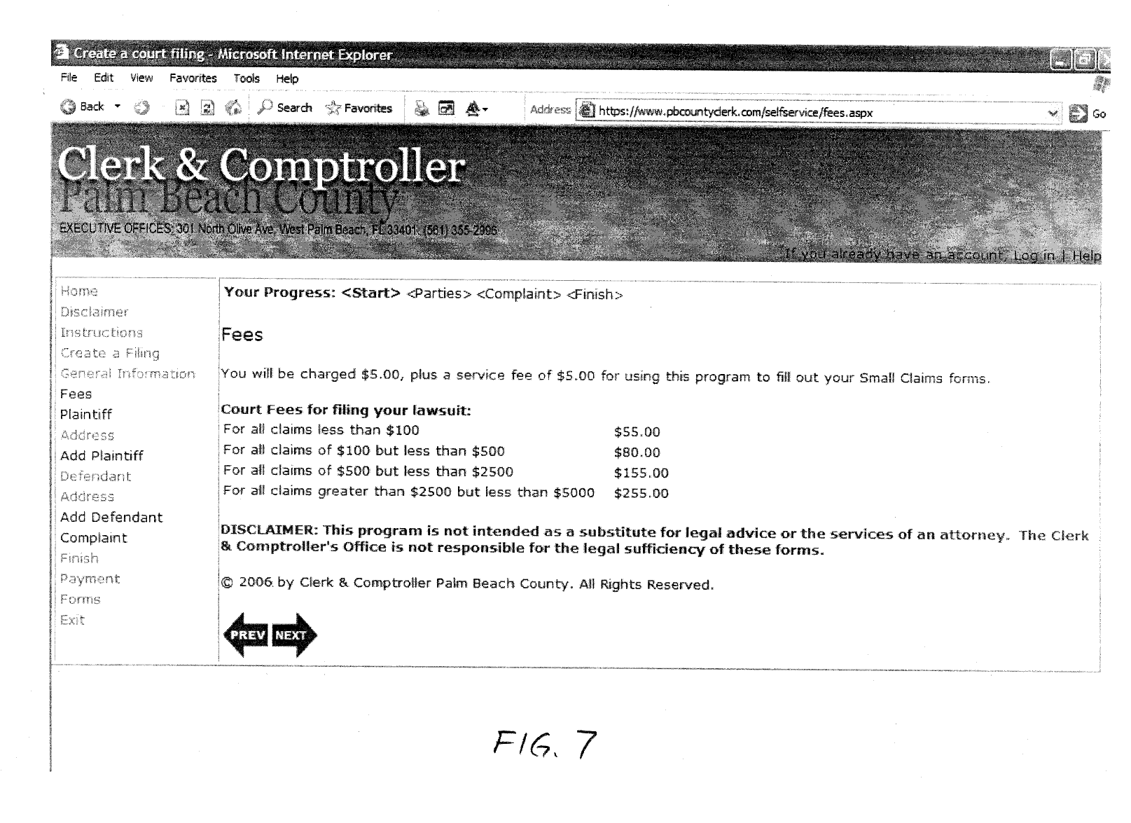

The user is now directed to a webpage (FIG. 5) which permits the user to choose a specific legal filing or proceeding, for example Small Claims, Eviction or Divorce. The choice is made by clicking on one of the radio buttons next to the specific filing. In the example shown a Small Claims filing has been selected. After a selection is made the software of the instant invention solicits information from the user by presenting sets of questions to be answered on multiple web pages. The information provided by the user is used to complete the documents or forms required for the legal proceeding or filing that the user has chosen. The legal forms are stored on the server system as image or text files. FIG. 6 illustrates the web page which is displayed at the beginning of a Small Claims proceeding. This web page solicits some of the information that must be obtained in order to provide the information required for this filing and links to sources of some of this information. This web page also contains a menu 32 on the left side of the page. This menu tracks the user's progress through the filing application by highlighting the different web pages which constitute the filing application. In the example shown the web page that the user is currently working on is black. The web pages that the user has completed are light blue and the web pages that have not been completed are dark blue. Next the appropriate court fees are listed (FIG. 7). These fees depend on the amount of the “small claim”.

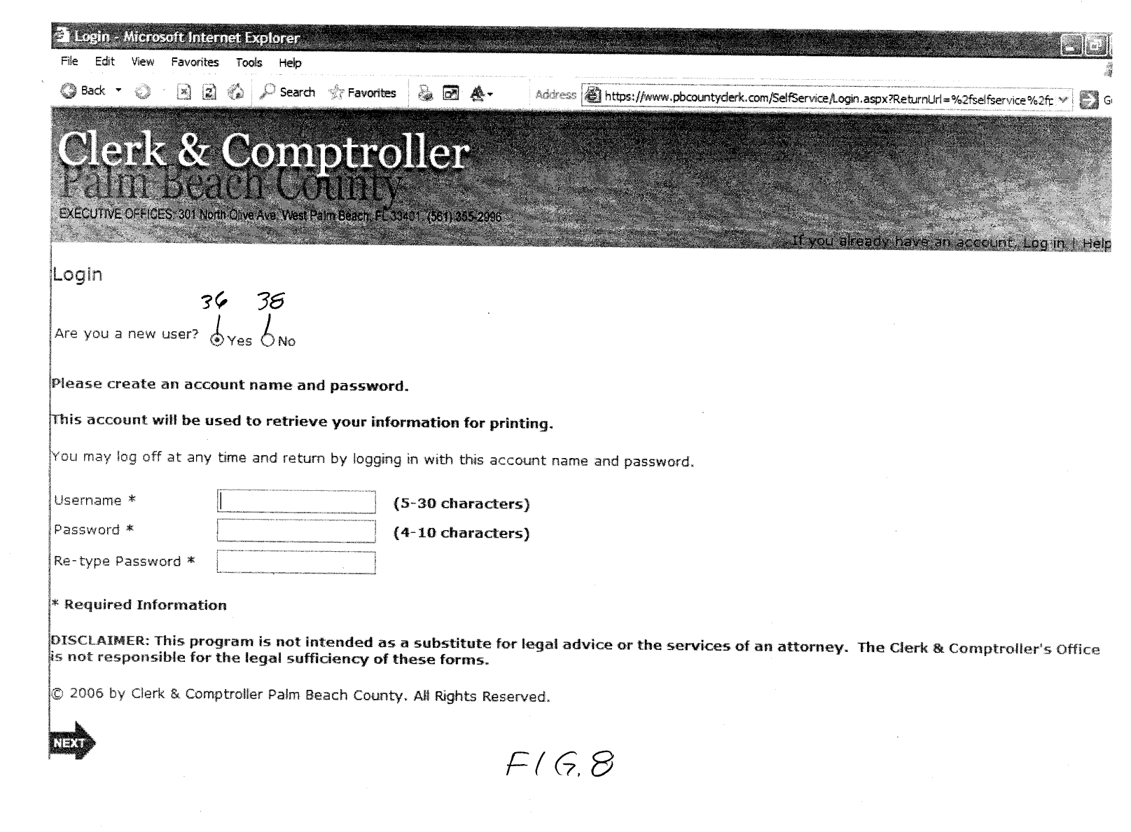

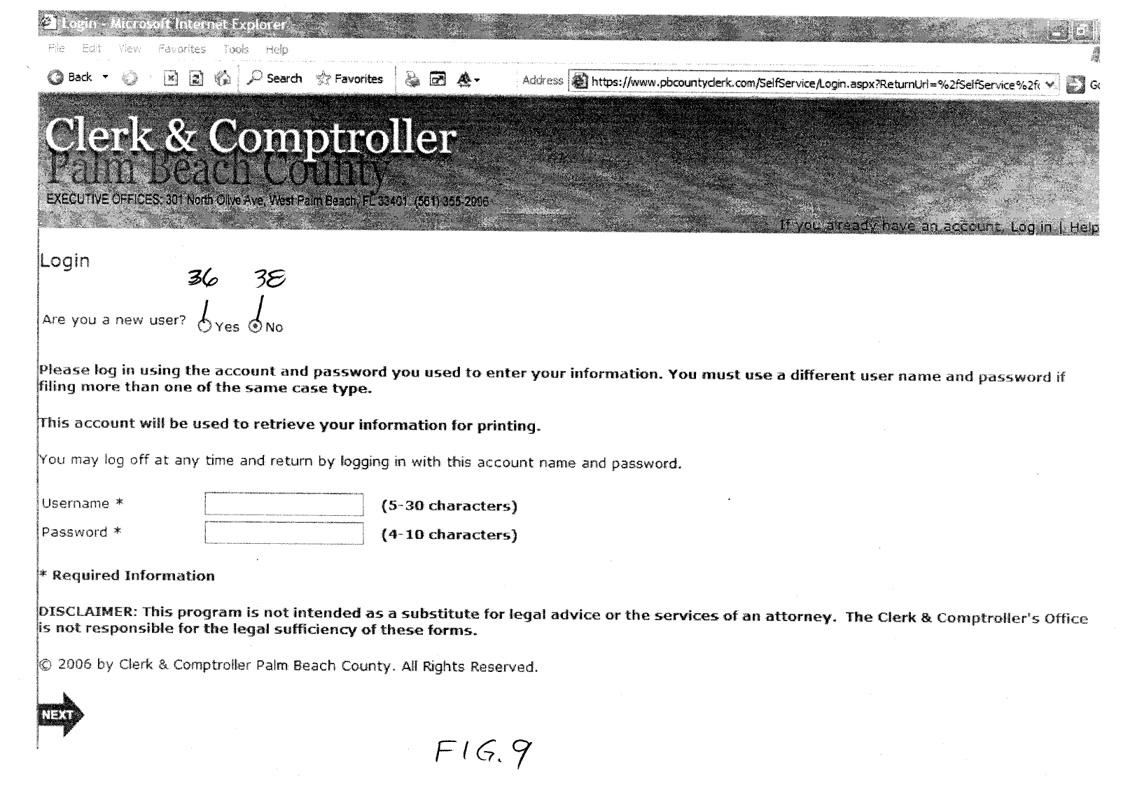

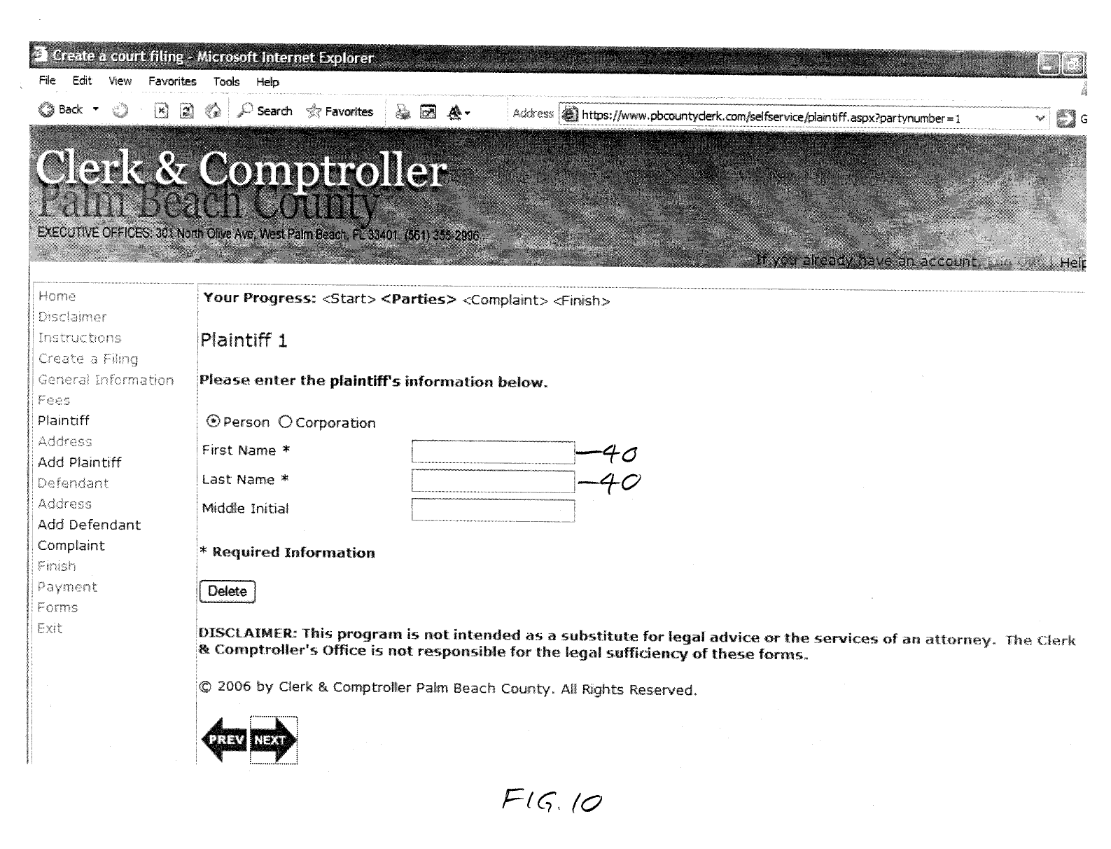

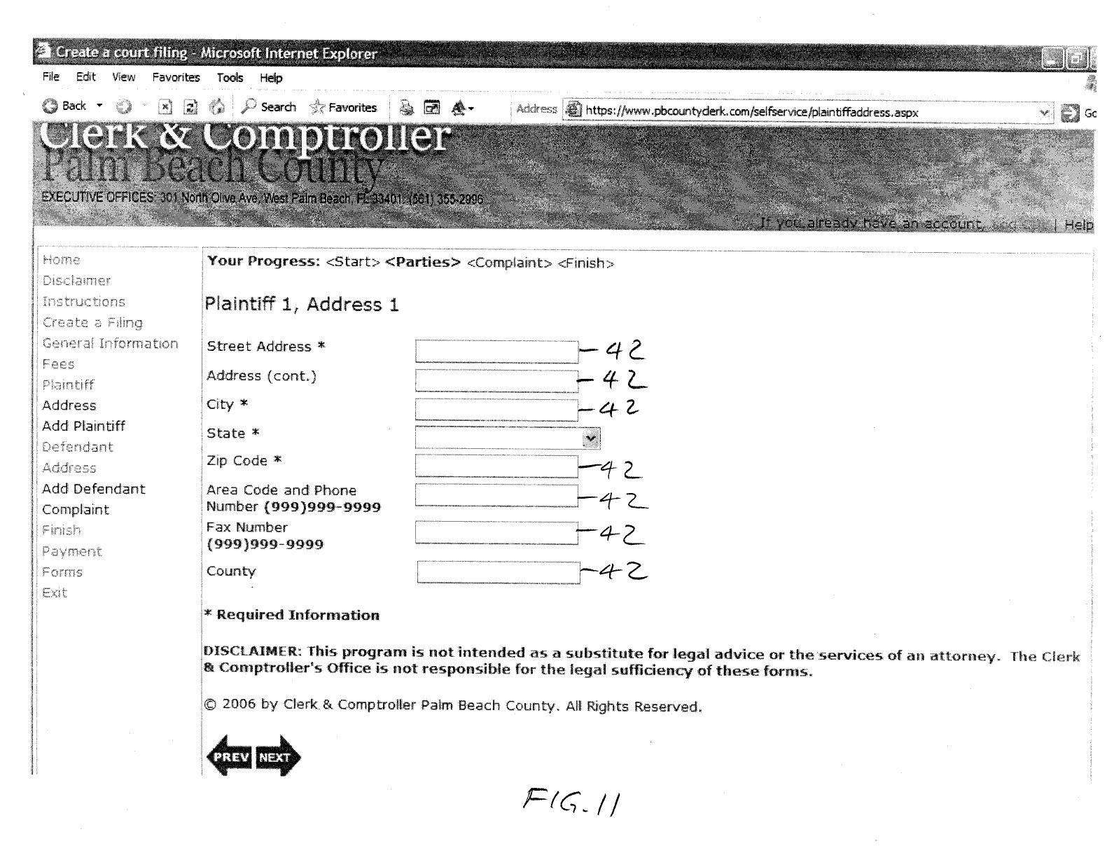

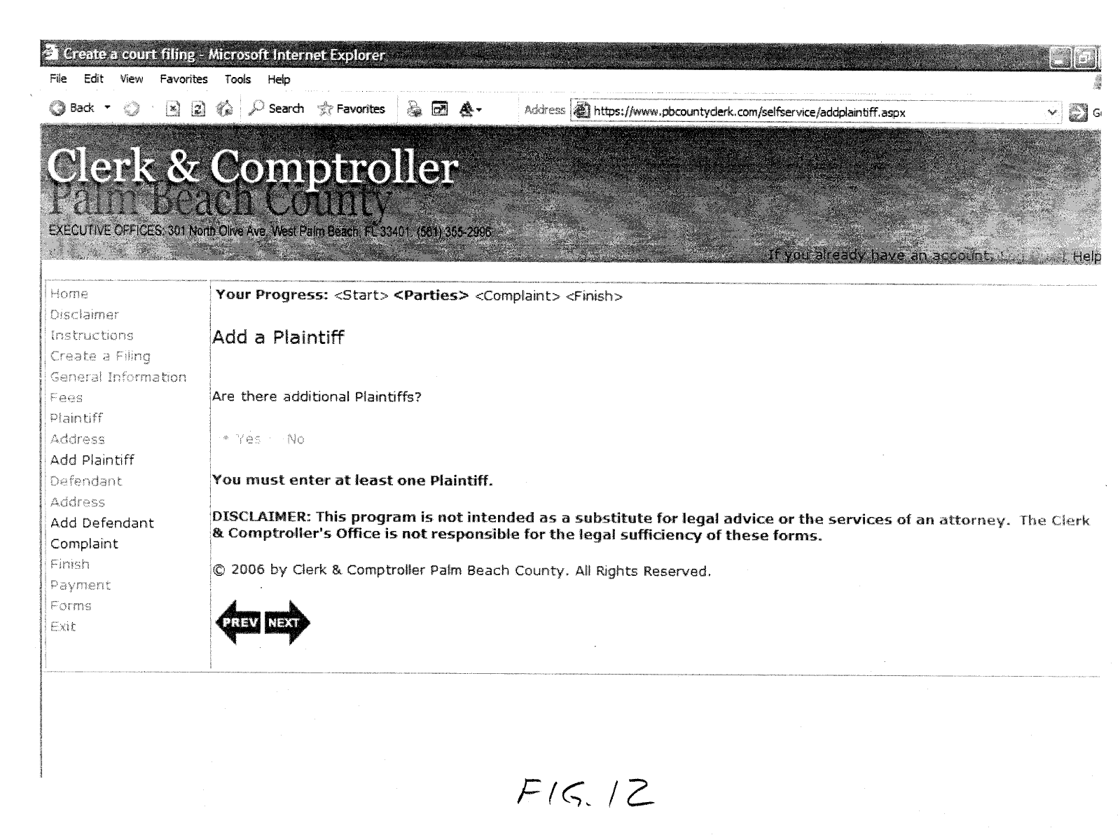

At this point the system application requires that the user “login” (FIG. 8). If the user is new to the system, they indicate this by clicking the “Yes” button 36 on the upper portion of the page and they can create a login ID and password at this point. If the user is already a register user in the system they would click the “No” button 38 on the top portion of the screen and enter their login ID and password, as illustrated in FIG. 9. This login ID and password permit the user to exit the system prior to completion of all the questions and return at a later time. For example, if the user does not have all of the required information at hand or the user does not have enough time allocated to complete all the questions. In a preferred embodiment the information related to an incomplete document or proceeding will remain in the system for a period of 10 days. On the next web page (FIG. 10) the plaintiff(s) is identified as a person or a corporation and their first and last name is entered into the areas provided 40. On this page and subsequent pages the basic information necessary to complete the forms or documents for filing in indicated by and asterisk (*). FIG. 11 illustrates the web page for providing the address and phone contact information of the plaintiff. The information is entered into the boxes or fields 42. FIG. 12 illustrates the web page wherein additional plaintiffs can be added.

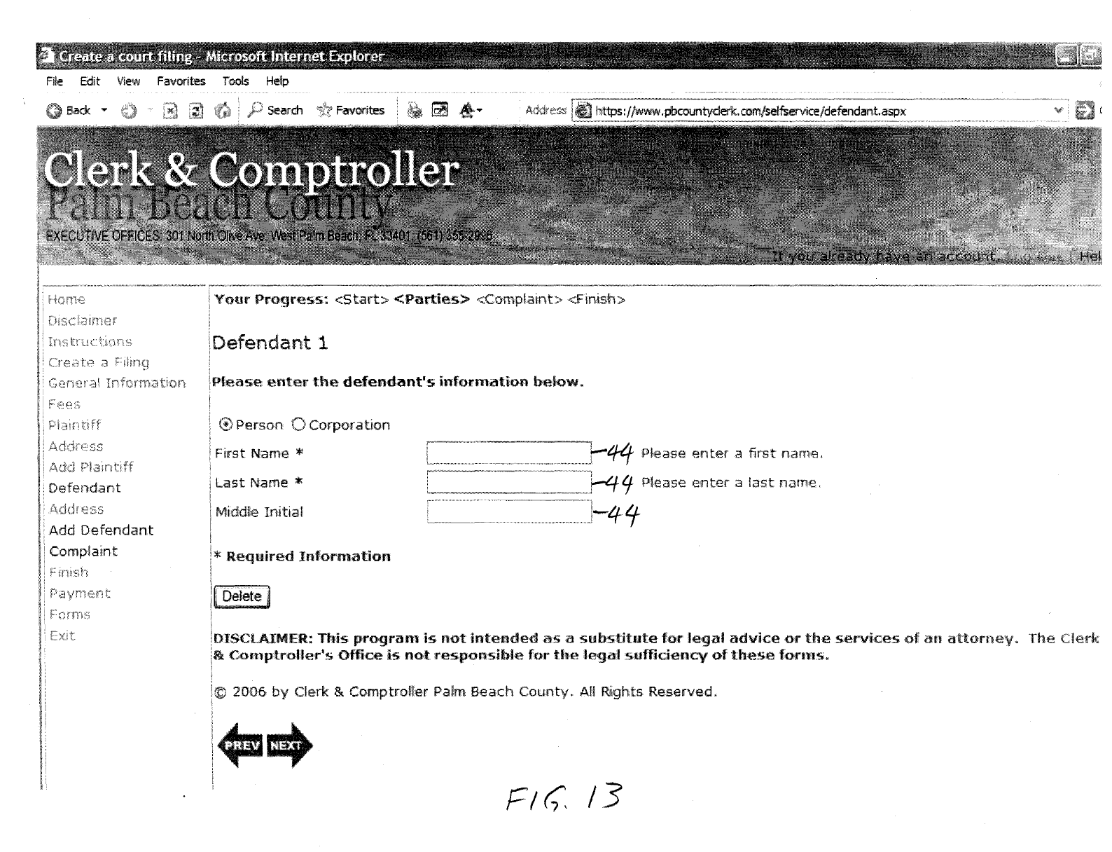

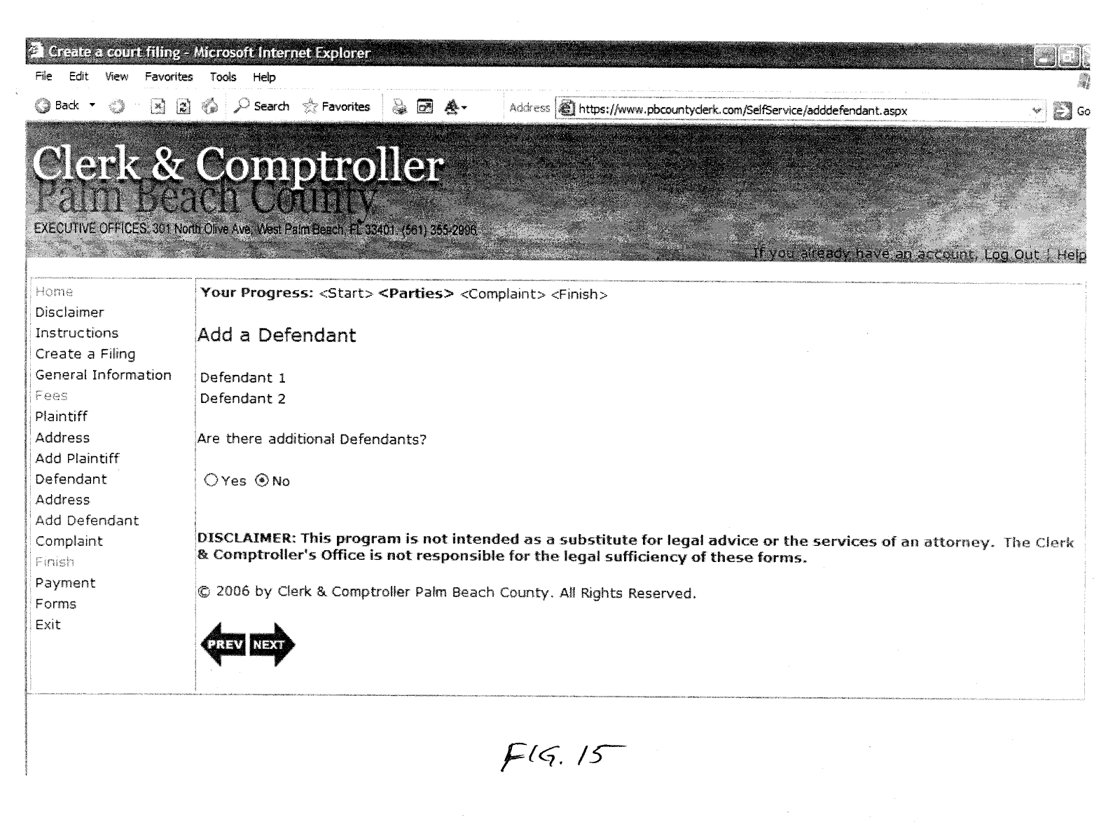

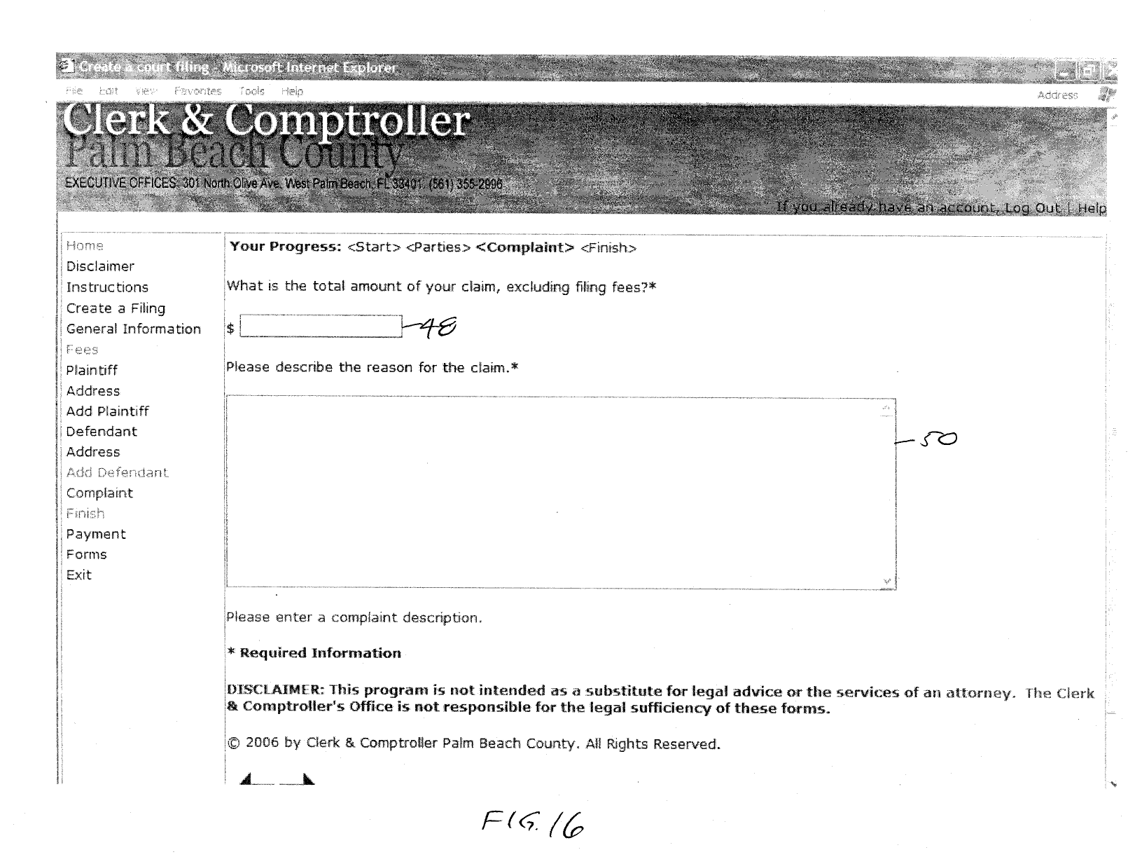

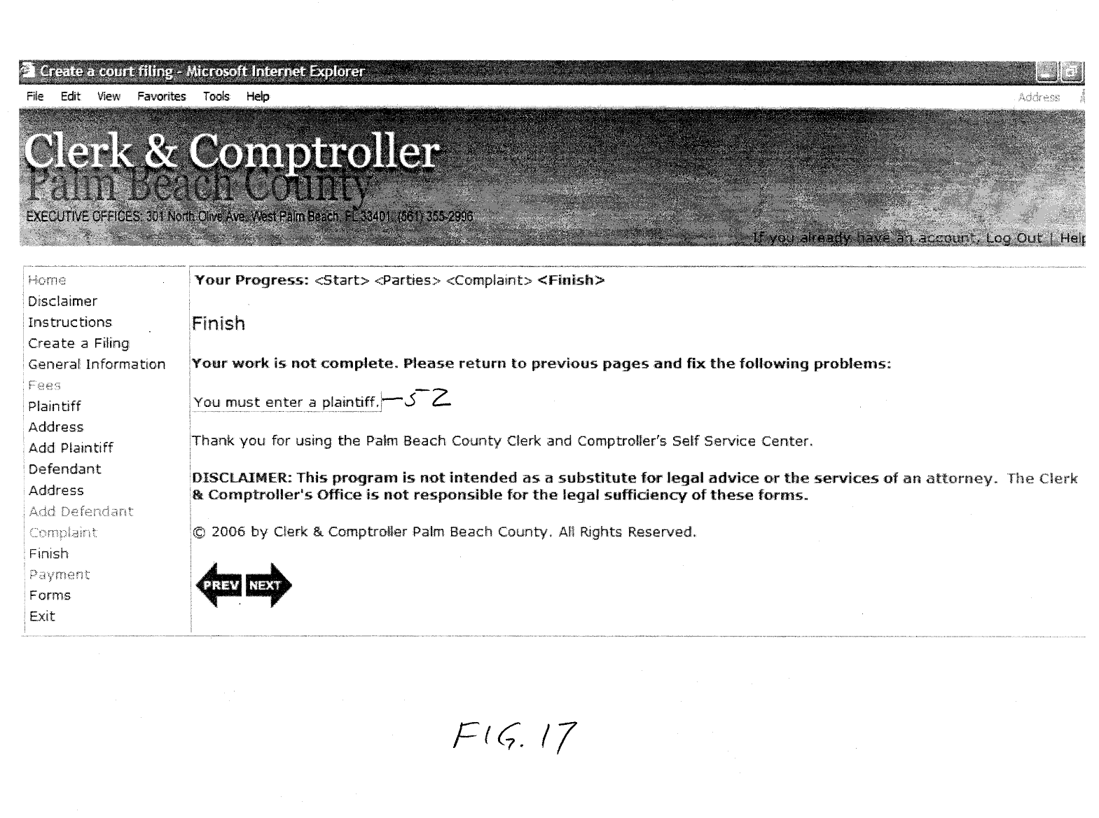

FIG. 13 illustrates the web page for identifying the defendant(s). The defendant's name is entered into boxes or fields 44. Next the web page for providing the defendant's address and phone contact information is shown in Fig. The information is entered into boxes or fields 46. FIG. 15 illustrates the web page wherein additional defendants can be added. Next the complaint information is entered on the web page illustrated in FIG. 16. This includes the monetary amount of the complaint, in box or field 48, and the reasons for the complaint, in box or field 50. FIG. 17 illustrates the “finish” page. If any information in missing or incorrect the user is notified at this point, as shown in box or field 52. The user will then be returned to the appropriate web page(s) to supply the missing data.

The above method employs a question and answer format, requesting the user to answer a series of questions to obtain information to complete the legal forms or documents. As an alternative, the system may ask the user to enter all of the same information in fields in a form, so that the user essentially sees all of the questions at once, rather than iteratively. In either configuration, the system solicits the information and verifies that the required information has been provided.

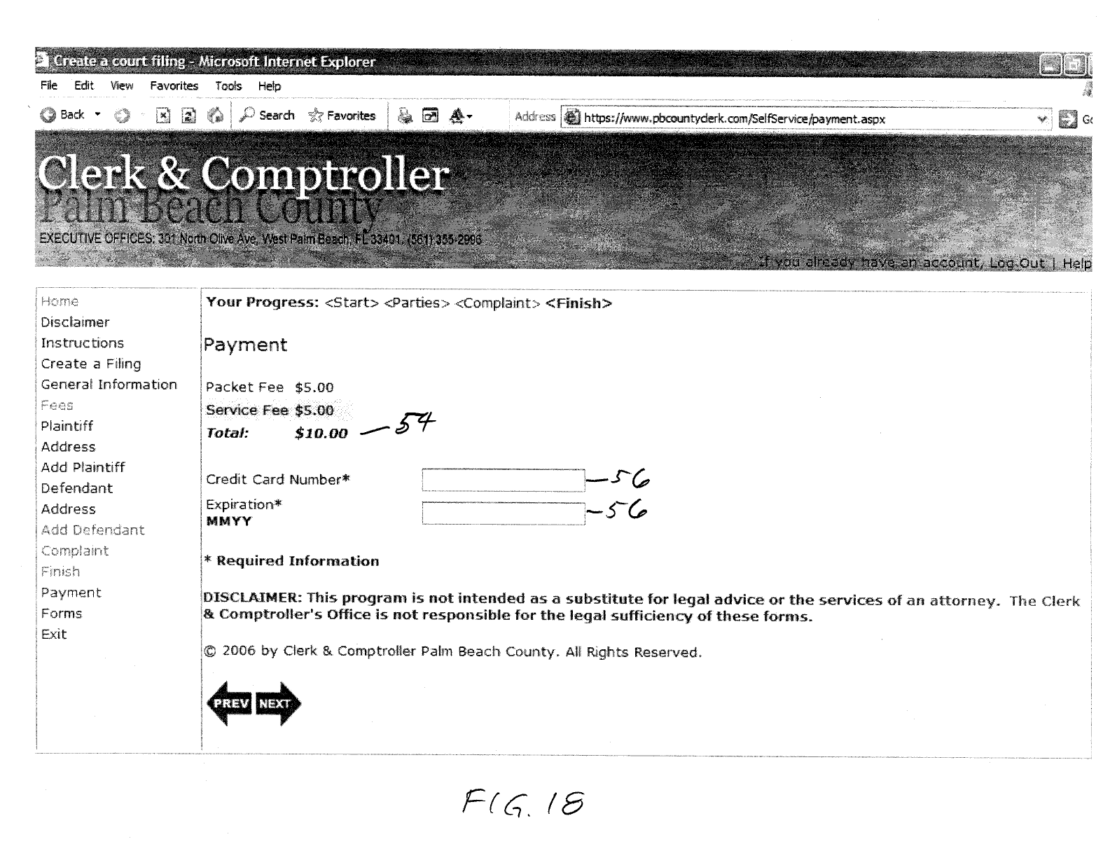

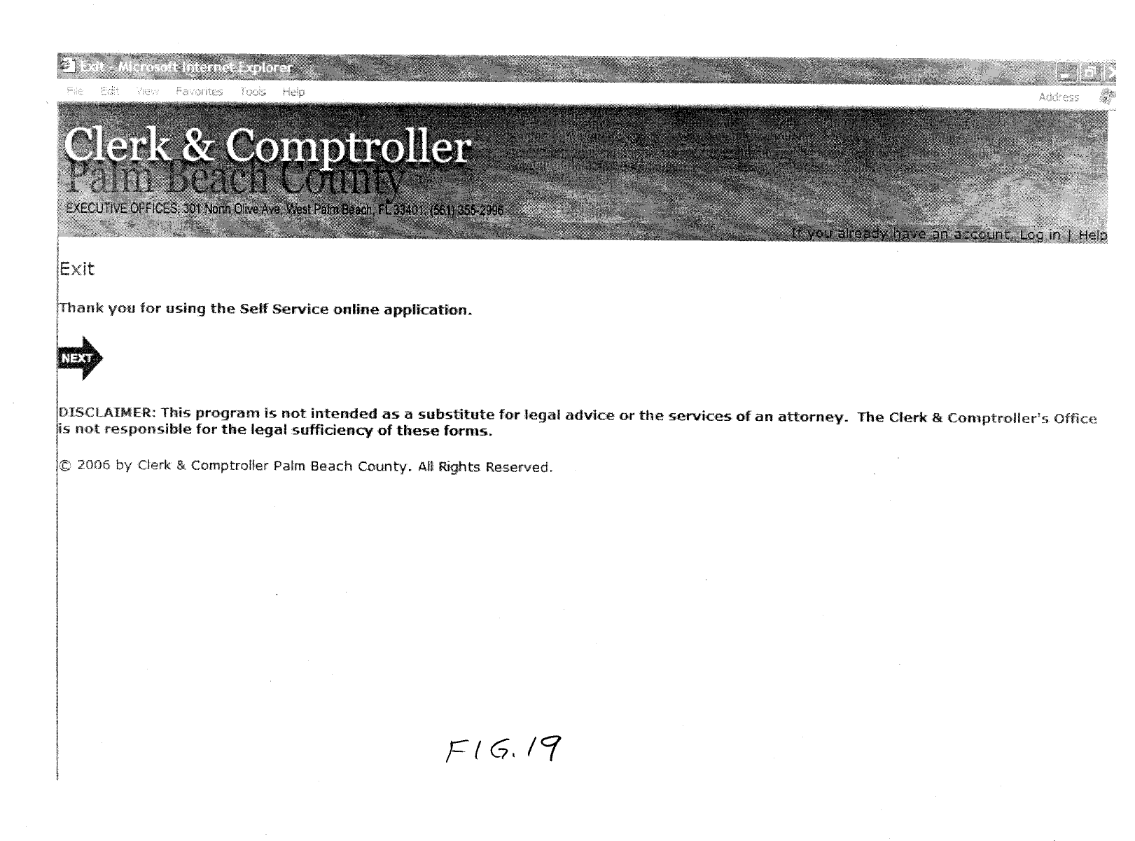

The next web page (FIG. 18) provides a list of the cost of the services 54 and provides boxes or fields 56 to submit credit card information for payment online. After the payment has been submitted, the completed court forms or documents are printed out. The user may then check them for accuracy. If the user is satisfied with the forms or documents they can then exit the system as illustrated in FIG. 19. The completed and printed forms or documents are then signed and notarized and filed with the proper court.

While the system will generate forms and documents automatically that are suitable for filing, certain users may prefer to obtain an attorney review of the documents, particularly in the case of divorce proceedings. There is a disclaimer on each web page indicating that this system is not intended as a substitute for legal advice or the services of an attorney. The choice resides with the user.

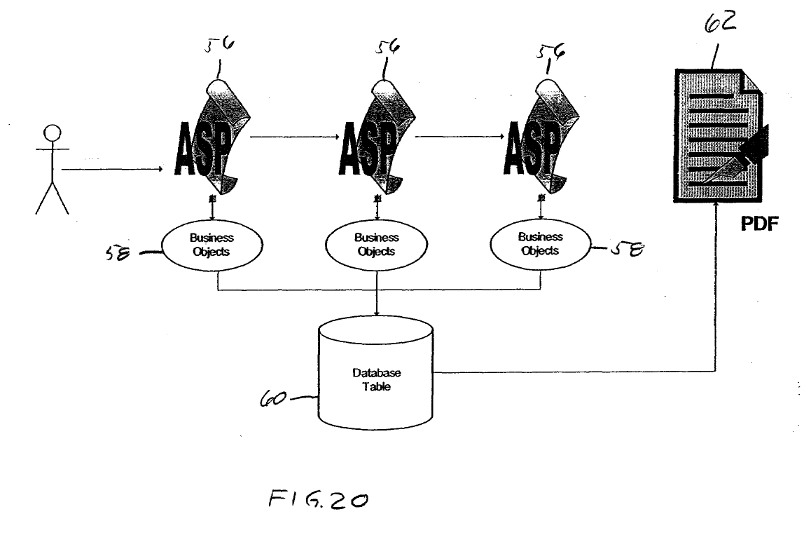

As illustrated in FIG. 20, the system application uses Active Server Pages 56, which are the web pages, to solicit information from the user. The information which the user enters is just raw data. This data is then classified and identified by the use of business objects 58 associated with each Active Server Page 56. For example, when the user provides the name of a plaintiff it is converted into a business object which identifies this data as the plaintiff. After the user has answered all the questions on a particular web page and thereby completed an Active Server Page, the data which was identified by the business objects is entered into the main database 60 in the memory of the system.

After all the questions have been answered the system application associates the identified data with the appropriate areas or fields on the legal forms or documents and completes the forms. These forms 62 are stored in the database in an area set aside for forms and documents. While these forms are preferably stored as PDF files other formats could also be utilized. After the user has indicated which legal proceeding they want to pursue the specific forms required for this proceeding are identified by the system application. The system application software then checks to see if any critical data missing. If there is missing data, the user will be notified prior to their exiting the system and returned to the appropriate web page(s) where the missing data may be supplied. When all the appropriate forms or documents have been completed and the appropriate fees have been paid, the forms are ready for printing. They can then be sent to a printer associated with the user's computer or terminal.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. An interactive form preparation system for guiding pro se litigants in preparing documents for filing of a lawsuit, said system comprising the acts of:
providing a computer server system;
providing a database of court mandated forms stored as image files on said computer server system;
providing a remote computer means for communicating with said computer server system, said remote computer means used to select a court mandated form particular to a court proceeding;
providing software executing on said computer server system to query said remote computer for information attributed to said court mandated form;
soliciting a service fee for accessing said court mandated filing form; and
generating a completed court mandated form based on the receipt of said service fee and said queried information.

2. The interactive form preparation system according to claim 1 wherein said software includes a graphic user interface to solicit said information from a user at said remote computer means, said server system including a memory for storing said information.

3. The interactive form preparation system according to claim 2 wherein said graphic user interface permits a user to proceed to subsequent graphic user interfaces without completion of a current graphic user interface.

4. The interactive form preparation system according to claim 2 wherein said graphic user interface can be restarted with previously populated data information if the interface is logged off for less than seven days.

5. The interactive form preparation system according to claim 1 wherein said court mandated forms are directed to small claim proceedings, eviction proceedings or divorce proceedings.

6. An interactive form preparation system for guiding pro se litigants in preparing documents for filing of a lawsuit, said system comprising:
a server system coupled to a network;
a remote system coupled to said network;
means to generate a graphic user interface which solicits said information from a user at said remote system in the form of questions, and said server system including a memory for storing said information and said documents;
said server system constructed and arranged to receive information from at least one remote system over said network;
said means to generate a graphic user interface includes means to generate successive graphic user interfaces to solicit additional information;
said means to generate a graphic user interface further includes an option wherein said user may proceed to said next graphic user interface without completing the current graphic user interface; and
said server system populating at least one document with said information.

7. The interactive form preparation system according to claim 6 wherein said user departs from said location prior to answering all said questions and returns to said location at a later time to complete the answers.

8. The interactive form preparation system according to claim 6 wherein said documents are directed to small claim proceedings, eviction proceedings or divorce proceedings.

9. The interactive form preparation system according to claim 6 wherein a service fee is obtained for accessing said form preparation system.

10. The interactive form preparation system according to claim 6 wherein said network is an internet.

11. The interactive form preparation system according to claim 6 wherein said network is an intranet.

12. The interactive form preparation system according to claim 6 wherein said graphic user includes a means for verifying form entry, said means for verifying includes a prompt for correction of an entry.

13. The interactive form preparation system according to claim 6 wherein said remote system is a kiosk.

14. The interactive form preparation system according to claim 6 wherein said graphic user interface requires payment of a service fee for printing of a completed form.
